(19) United States
(12) Patent Application Publication
(10) Pub. No.: US 2004/0172403 A1
(43) Pub. Date: Sep. 2, 2004

(54) Method and system for automated tracking of persons at remote activities

(76) Inventors: Rhea L. Steele, Chicago, IL (US); Cheryl D. Taylor, Chicago, IL (US); Kenneth L. Day, Chicago, IL (US)

Correspondence Address: BRINKS HOFER GILSON & LIONE, POST OFFICE BOX 10395, CHICAGO, IL, 60610, US

(21) Appl. No.: 10/723,300

(22) Filed: Nov. 25, 2003

Related U.S. Application Data
(60) Provisional application No. 60/429,198, filed on Nov. 26, 2002.

(51) Int. Cl. G06F 17/00

(52) U.S. Cl. 707/100

(57) ABSTRACT

A system for an automated tracking of a person at a remote site comprises a person tracking device to capture data related to biological characteristics and location coordinates of a person being tracked, a Global Positioning System (GPS) database to certify the location coordinates of the person being tracked as communicated by the person tracking device, a personal enrollment center including a master database that stores biological characteristics and records location coordinates of the person being tracked, and a communication network to operably connect the person tracking device, the master database, and the GPS database. The tracking device compares the captured biometric data of the person being tracked with the stored biometric data of registered persons to validate the identity of the person being tracked or to record the captured biometric data of the person being tracked as a non-registered person, and communicates the captured data and location coordinates to update the master database.

This application claims the benefit of U.S. Provisional Application No. 60/429,198 filed Nov. 26, 2002.

### FIELD OF THE INVENTION

The present invention relates to tracking systems. In particular, the present invention relates to a method and system for tracking persons during remote activities.

### BACKGROUND OF THE INVENTION

In an increasingly safety conscious society, it is often desirable to know the whereabouts of loved ones, especially children, when they are out of the immediate control and sight of families or caregivers. For example, when a child boards a bus for transport to school, the child's parents would likely find it beneficial to know that that child has arrived at school safely. In addition, the destination school would also benefit from information relating to the child's location to assist in determining the whereabouts of the child. Or, when a group is on a ski trip, it would be useful to determine whether a member of the group is either at the start or end of a ski run. Numerous other applications would find similar person locating information useful.

Location-aware systems, such as Global positioning systems (“GPS”), have been in use for a number of years to track vehicles and, to a more limited extent, people. Such systems have not been widely available to track individual persons on a large scale, however. Furthermore, such systems are often cost prohibitive for application to the general public on such a scale.

Ticketing, ID and admission methods can help pinpoint the location of a person during a particular activity. These methods do track the location of persons on a mass scale, but they tend to do so only partially. For example, while some passenger train operators acknowledge the boarding of passengers on long distance routes through the use of tickets and boarding passes, they do not affirmatively confirm the exit of the passenger at the destination. The confirmation of arrival of a particular person at a destination after transport is critical to knowing the whereabouts of that person. Typically, however, the location of the person is often not available to remote persons other than those at the entity or location issuing the tracking item.

Another shortcoming of the present methods described above is that these methods typically require the use of a tracking item, such as a ticket, to partially confirm the location of a person. The tracking item could also be a bulky electronic device, such as a GPS transponder that requires power and the ability to carry the device. Such methods require that the person carrying the tracking item do so dependably and somewhat consistently to prevent the generation of inaccurate location information. These requirements likely rule out the use of such methods for the tracking of children, or for tracking when the tracking item is easily lost or cannot be carried easily.

### SUMMARY OF THE INVENTION

The present invention provides a tracking system and method for tracking and acknowledging the location of individuals during remote activities. The presently disclosed embodiments include a mobile biometric and location tracking system utilizing state-of-the-art biometric and GPS technologies to automatically verify the identity and register the exact location of persons. The present system may be utilized efficiently in limited bandwidth environments.

The present invention advantageously utilizes the combination of biometrics with GPS to insure personal location tracking, while allowing an organization or individuals to track and manage groups and individuals.

The use of biometrics guarantees that each person being tracked is truly the person expected. Other methods of identity verification such as ID cards, passwords and personal information can be lost, stolen or forged. Biometric identification uses personal biological characteristics that cannot be duplicated and guarantee that the person being identified is the person originally registered.

The use of the GPS technology further enhances the tracking ability by registering the precise location at the moment a person is verified. This ability can be critical in applications such as the transporting of children on a school bus or a large theatre company in a traveling show.

In one aspect of the invention, the tracking system provides Internet available location information that integrates GPS data and biometric recordings taken at key points at a remote site. Biometric data may be recorded for individuals at the beginning and end of transportation segments, and the location of the transportation segments may be confirmed and tracked through the use of GPS data. Internet messaging protocols are used to manipulate, transport and store the data to allow for the maximum flexibility in all implementations. Further biometric recordings may be made at a remote destination site. The biometric data and GPS information are then integrated into a confirmation record that may be used to report the verified location of an individual that is registered to use the system. This record may be obtained via the Internet or any other wireless network.

The system and method of the present invention can provide automated tracking of people for a remote organized activity. Activity information can be registered in advance with assigned lists of people, or created on site at the start of the activity, depending on the level of security needed. Each person's biometric information is captured at time of registration along with a photograph, all of which are loaded into a master/central database on a secure server which can be hosted and managed by a third-party provider or by the customer.

As people enter and leave the remote site, the remote administrator will have the ability to verify the identity of each person and create a record of the person's activity. Each remote site will have a handheld PC, or a pocket PC or the like, with a biometric reader unit and a GPS receiver unit. As such, as people enter and leave the remote site, they may place one of their enrolled fingers on the biometric reader. If the person has been registered for the activity, their correspondingly individual biometric information can be appropriately matched and the GPS reader may record the exact location. However, if the person has not been previously registered, the administrator can create a corresponding manual activity record. To do so, the administrator may enter the person's relevant information into the pocket PC by filing out an appropriate number of dialog fields on the pocket PC screen, or by any other suitable manner. Subsequently, the entered relevant information may be stored locally in a queue on the pocket PC and/or automatically transferred to the central database via a wireless Internet connection, when available. Further, participants associated with the organized activity can view updated personnel list data and reports via the Internet.

An embodiment of the present invention is based on a web-enabled, multi-user platform/system using standard Internet messaging protocols. The web-enabled multi-user system may include the following features: high compatibility with available and off-the-shelf hardware and software components, ease of use and installation, high reliability and low maintenance, as well as flexibility and scalability to meet changing needs and budgets.

The web-enabled system may be designed around automated Extensible Markup Language (XML) protocol, composition, publishing, distribution and interaction. Since XML is easy to use (and ubiquitous), the system may store and distribute user data including e-photos and e-fingerprints, scripts and software components, as well as user transaction, confirmation and location data.

The above described features (procedures) can be used in diverse applications such as remote time and attendance tracking, passenger tracking, and school field trips or organized outdoor activities such as mountain climbing and hiking.

Additional features and advantages of the present invention will become more apparent to those skilled in the art from the following description of the preferred embodiments of the invention which have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS:

FIG. 1 illustrates a schematic system diagram of a first embodiment of the system of the present invention;

FIG. 2 is a schematic system diagram of the various software modules that may be implemented in the embodiment of FIG. 1;

FIG. 3 is a diagram of the server personnel setup module of FIG. 2;

FIG. 4 is an illustration of an input record screen for use in conjunction with the software of the first embodiment;

FIG. 5 is a diagram of the handheld update module of FIG. 2;

FIG. 6 is a diagram of the personnel biometric registration module of FIG. 2;

FIG. 7 is a diagram of the personnel data recording module of FIG. 2;

FIG. 8 is a diagram of the personnel tracking module of FIG. 2; and

FIG. 9 is a flow chart illustrating an embodiment of the method for tracking automated persons at remote sites;

FIG. 10 is a flow chart illustrating a personnel enrollment segment of the method for automated tracking of persons;

FIG. 11 is a flow chart illustrating a personnel fingerprint registration segment of the method for automated tracking of persons;

FIG. 12 is a flow chart illustrating a procedure for a personnel tracking information download segment of the method for automated tracking of persons;

FIG. 13 is a flow chart illustrating a remote tracking segment of the method for automated tracking of persons; and

FIG. 14 is a server data model of the database utilized in conjunction with the software of the first embodiment.

### DETAILED DESCRIPTION OF THE PREFERRED EMBODIMENTS

The present embodiments of the invention provide a tracking system and method for tracking and acknowledging the biometric identity and relative location of individuals during remote activities.

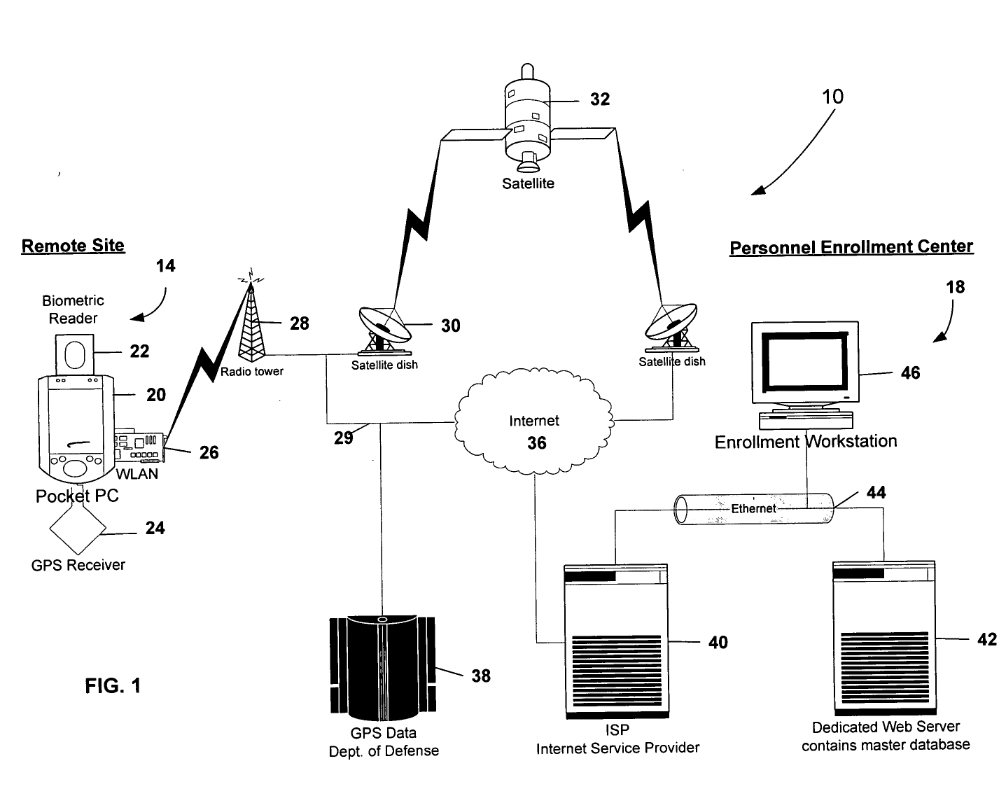

FIG. 1 illustrates a network 10 of a first embodiment of the present invention. The network 10 comprises a remote site 14 operably connected to a personnel enrollment center 18 to track and acknowledge the location of individuals. The remote site 14 comprises a handheld personal computing device 20 (“handheld PC”), further comprising a biometric reader unit 22 and a GPS receiver unit 24 preferably connectable thereto. The handheld PC 20 provides mobile access for the remote administrator to interact with remote users and a software module, as described below. The biometric reader unit 22 provides the ability for a remote administrator to validate remote users through the PC 20 by capturing tracked individuals' biometric data, such as the information relating to the fingerprints of each tracked individual. The GPS receiver 24 provides location-aware services to a remote administrator through the handheld PC 20 to capture geographical/location coordinates for confirmation and locational transactions.

The handheld PC 20 may further comprise any acceptable, small computer device, such as a laptop, PocketPC handheld, mobile telephone or Palm-based handheld computer. In the present embodiment, the handheld PC 20 is a PocketPC model available from Hewlett Packard, Inc. running PocketPC software available from Microsoft Corporation. Of course, any number of alternative devices may be used to implement the present system. Furthermore, despite the present nomenclature, those skilled in the art will recognize that operating systems other than “PC” operating systems may be used.

Preferably, the handheld PC 20 is in communication with a WLAN transceiver unit 26 or mobile cellular or digital modem. The WLAN transceiver unit 26 may in turn communicate with a cellular radio tower 28 for transmission of identification data to a satellite uplink transmitter 30 as shown. The identification data is used to identify the particular handheld PC 20 that is connected to the WLAN so that global positioning information for the particular remote site 14 may be relayed from an orbiting satellite 32 back via the downlink transmitter 34.

Alternatively, GPS information may be downloaded using the downlink from the satellite 32 and merged with known positional data via the link 29 directly to the remote site 14. The handheld PC 20 may then transmit data via the LAN and the Internet 36 directly to the enrollment center 18.

On the downlink side, a receiving station 34 receives satellite downlink data via the Internet 36. Other private networking links may also be used. From the Internet 36, the signal from the remote site 14, confirming geographical coordinates and identifications from the biometric reader 22, is sent via the Internet 36 to the personal enrollment center 18. A Department of Defense database 38 connected to the Internet 36 confirms geographical coordinates from the GPS receiver 24 at the remote site 14. An Internet service provider 40 and a dedicated web server 42 containing a master/central database connect via an Ethernet connection 44 to an enrollment workstation 46 at the personnel enrollment center 18. A procedure for enrollment is described below.

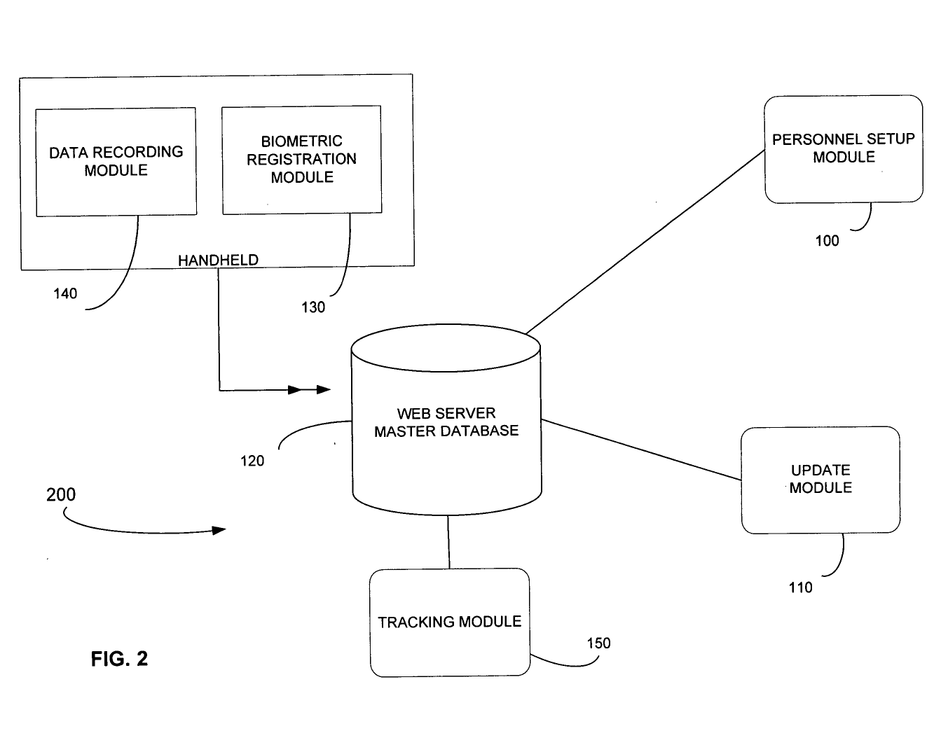

FIG. 2 illustrates a software embodiment 20 implementing a method of the present invention. The software comprises a plurality of modules operating on a database housed within the dedicated web server 42. As shown in FIG. 2, the web server master database 120 is in communication with a number of software modules, namely a personnel setup module 100, an update module 110, and a biometric registration module 130 and a data recording module 140 (both linked wirelessly to the master database 120). A tracking module 200 is also in communication with the database 120. The Personnel setup module 100 operates on the server 42 and adds the initial information into the master database 120. The update module 110 operates on the server 42 and automates the sending of records that need to be tracked on the handheld PC units. The biometric registration module 130 operates on the handheld PC units and extracts the identification metric to be sent back to the server 42. The personnel data recording module 140 operates on the handheld PC and assembles the tracking information to be sent back to the server 42. Finally, the tracking module 200 operates on the server 42 and provides an interface to present the tracking data to a report or web screen.

The communication links illustrated in FIG. 2 may be any known links, such as hardwired Ethernet links, the Internet, or other internal software linked connectivity. As noted above, preferably the master database 120 is housed within the dedicated web server 42, and includes a Microsoft Message Queue (“MSMQ”) server program for controlling the functionality of the server 42.

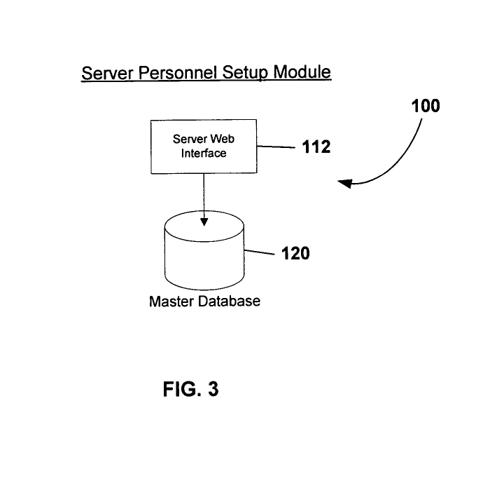

FIGS. 3-8 illustrate the individual components of the software module of an embodiment of the present invention. FIG. 3 shows a server personnel setup module 100. The setup module 100 comprises a software module server web interface 112 to provide input of personnel identification to the MSMQ. The setup module 100 operates on the server interface 112 and adds the initial information into the master database 120. The master database 120 will be used to store information on all enrolled personnel to be tracked. Initial personnel information must be collected and stored in the master database 120 prior to deployment via a handheld module, described below. A web-based form is used to enter the appropriate personnel data into the master enrollment database 120. The amount and type of personnel data to be stored can be customized based on the user's criteria. Examples of information to be stored in the master database 120 includes the individual's name, social security number or other unique identifier, work locations or routing information, employer identification information, and a photograph.

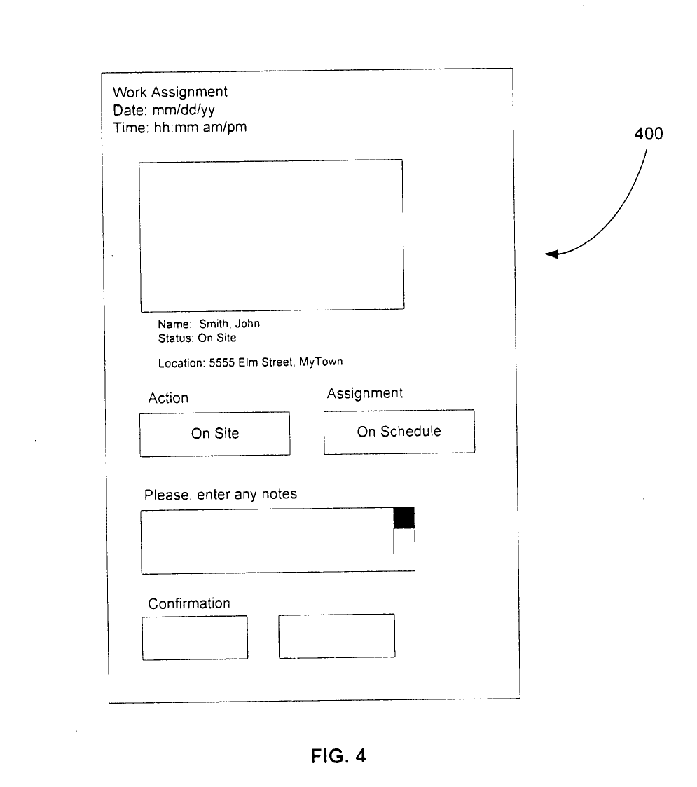

In accordance with the invention, one or more MSMQ queues can be set up to store data and forward data, much like a database. Typically, one queue represents all the remote sites under a public queue folder. Rules to process messages can be implemented many ways but typically “trigger event” scripts are associated with queues and are designed to work on allowable queue message types. Each remote user assignment consists of an XTML formatted message to be responded to by a confirmation reply from the remote administrator via the handheld PC. The assignment message is actually an HTML page, or Webform. This Webform consists of both dialog elements and program script to interact with the remote administrator for the purpose of creating identity confirmation response XML messages. Example of input fields on the Webform may be seen in the example of FIG. 4. Finally, to complete the setup, the remote administrator submits the Webform using either the Visual or Fingerprint button to conform the identity and post action, assignment and notes data over the Internet to a central MSMQ server.

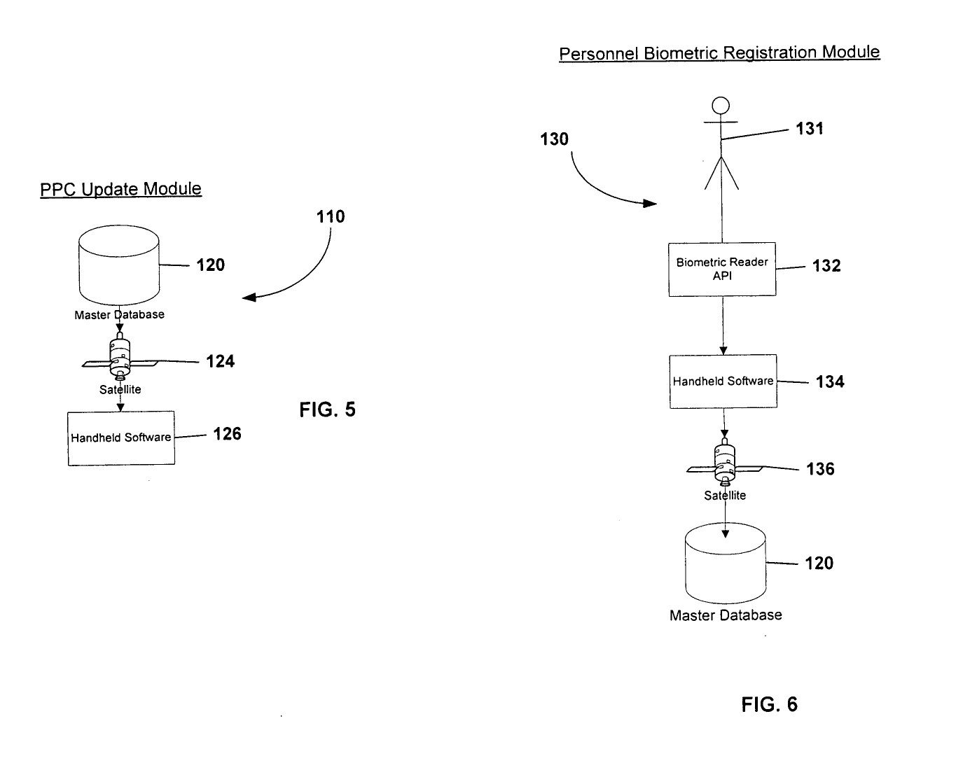

FIG. 5 shows a handheld PC, or a Pocket PC (PPC), update module 110. The handheld PC update module 122 uses the master database 120 to update user records into XML message files and transmit the message files via a satellite 124 or other remote network to a handheld PC 20 with web browser capability. The handheld PC 20 includes its own software routine 126 that retrieves XML messages and parses them into user records in the data storage area of the handheld PC. As noted above, the handheld PC may be any PC commonly known in the art such as a windows-powered pocket PC to provide mobile access for the remote administrator to interact with the remote users and the software module server resources.

FIG. 6 illustrates a schematic diagram of the personnel biometric registration module 130. As described above, the module preferably resides on the handheld PC 20, and operates to receive and process biometric data from a tracked subject 131 via a biometric reader 22. As presently contemplated, the biometric reader 22 is attached to the handheld PC 20 as is known in the art. As shown in FIG. 6, the biometric reader application program interface 132, also residing on the handheld PC 20, operates the reader 22 and receives and registers the metrics from the subject 131. A software sub-module 134 residing on the handheld PC 20 records the fingerprint record in an XML message and assembles an MSMQ message containing the fingerprint record. The message is then sent to the central MSMQ server 42 using a wireless communication protocol, such as the satellite system 136 or any other wireless LAN or mobile device. The server software at the dedicated web server 42 then receives the MSMQ message and extracts the fingerprint metrics to update the master user records in the master database 120 at the personnel enrollment center 18.

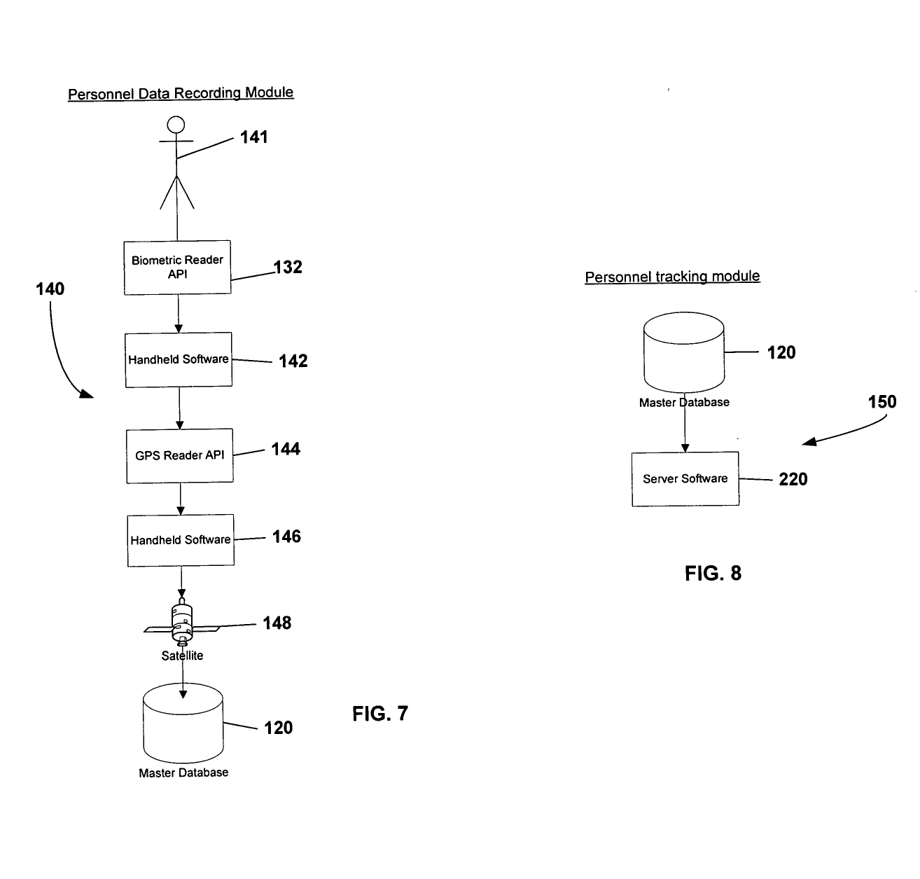

FIG. 7 illustrates the personnel data recording module 140 operating on the handheld PC 20. The data recording module 140 operates similarly to the biometric registration module 130 and utilizes the same hardware resident on and attached to the handheld PC 20. The purpose of the recording module 140 is to input biometric data, verify it against a local stored roster list, and process the data to form a tracking record to record location information for the tracked individual. Subsequent to a scanning of a fingerprint of a tracked subject 141 on the handheld biometric reader 22, the biometric reader application program interface 132 then matches and verifies the fingerprint metrics against the local stored roster list compiled as a subset from the master database 120, transmitted and assembled for use in this remote location

A subroutine 142 of the handheld software assembles an html file or Webform using the matched person data and presents the user interface on the handheld 20 for remote site confirmation by the site administrator. At that time, an application program interface (API) 144 for the GPS reader 24 on the handheld 20 activates the GPS reader 24 to retrieve the GPS location metrics from low orbit GPS satellites (not shown). A second software subroutine or module 146 residing on the handheld PC 20 then creates an message queue record containing the user information, date, time and location metrics and stores the record in a local message queue that will upload data (when a network connection is available) information to the master (message queue) database 120 residing on the server 42 of the personnel enrollment center 18. The message queue contents are then processed using the MSMQ server program, which formats it for processing by a database stored procedure on the server database 120. The database 120 is modified to append or insert the information in the message contents to the activity table for the particular user.

FIG. 8 illustrates a schematic diagram of the Personnel tracking module 200 that is linked to the master database 120. The module 200 includes server software 220 that processes user records within the database 120 and generates tracking reports. The reports are in turn provided to the various reporting devices, such as handheld PCs, web interfaces, or Internet-linked PC terminals by request. The reports can indicate the verified location of requested personnel accurately, and provide other travel and location information, such as GPS and arrival confirmation data.

Preferably, the present embodiment implements a small API to assemble separate biometric templates or Maps into control files. When a person is enrolled, the Map is saved into the local message queue store as an Enrollment message. The Enrollment message with embedded Maps are then uploaded to the central message queue server 42 and reformatted for insert into the person's master db record.

When an administrator creates work assignments and personnel lists for a remote site, a SQL template script on the central Web application server 42 is called automatically and Maps are assembled into an XML group activity file. This group activity file is pulled as an HTTP GET request by the remote biometric device, and stored as a local activity (or roster) file for selection and assignment as required by the remote administrator.

When the biometric device is asked to validate a person who is not in the local activity file, a separate subroutine is called to query the administrator to select the user from a pre-assemble Select list built from the currently assigned activity file and create an override activity transaction.

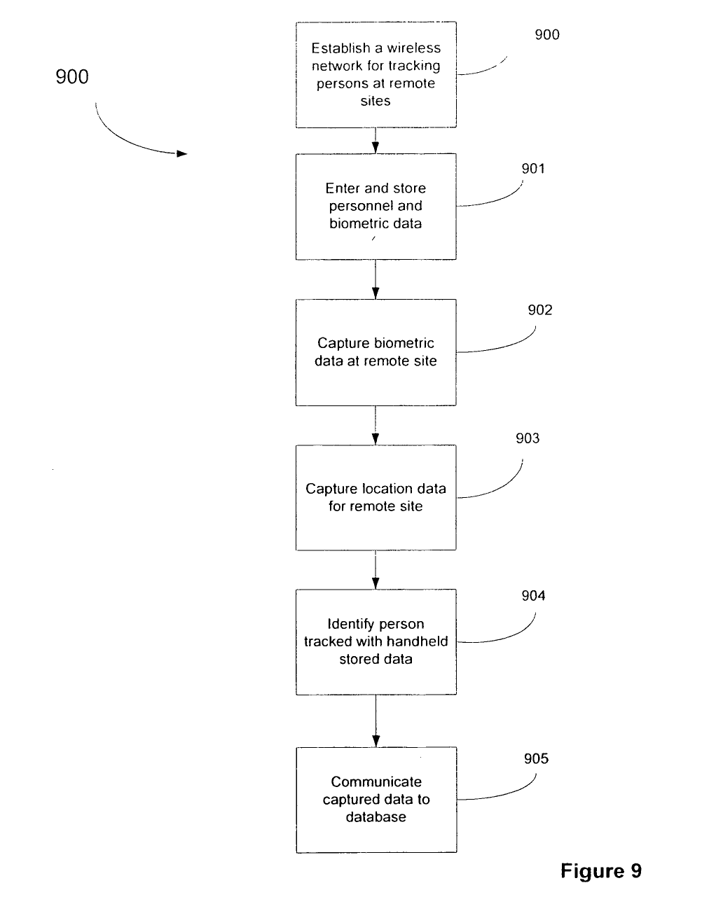

Referring to FIG. 9, a flow chart 900 illustrates an embodiment of the method for tracking automated persons at remote sites. At step 900, a wireless network system for automated tracking of a person is established by providing a person tracking device at a remote site, the person tracking device comprising a biometric reader, a GPS receiver, a data recording module, and a transceiver in wireless communication with the network, and the network further comprising a GPS database and a personal enrollment center including a master database. Then, the personal, pictorial and biometric data of registered persons is entered at the enrollment station and stored in the master database, at step 901. At the remote sites, the biometric data of a person being tracked is captured via the biometric reader, at step 902. While, the location data of the person being tracked is captured via the GPS receiver, at step 903. Subsequently, the tracked person is identified via a validation of the captured biometric data against pre-stored biometric data in the data recording module, at step 904. The captured biometric data and location data is then communicated to update a tracking module associated with the master database or to record the captured biometric data of the person being tracked as a non-registered person within a personnel setup module, at step 905.

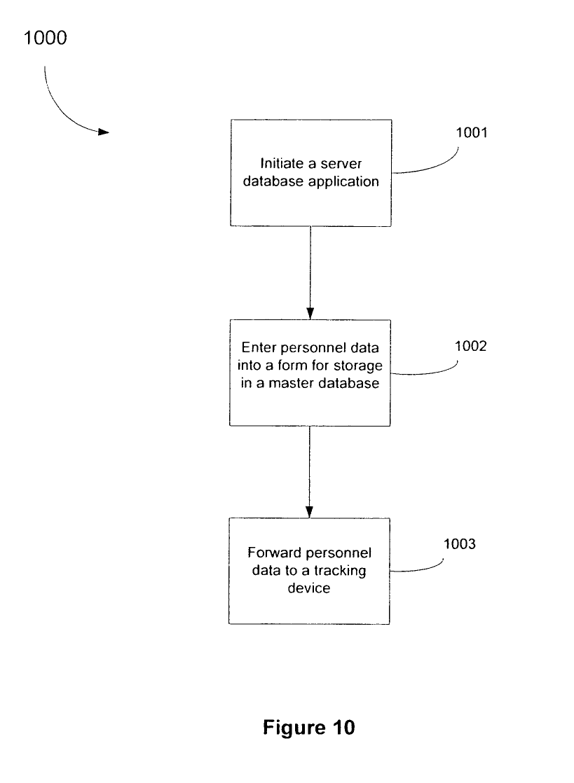

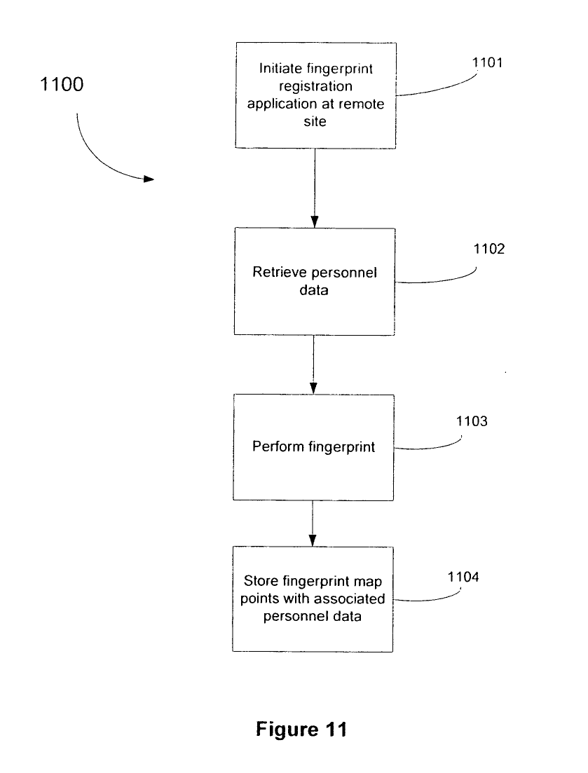

In accordance with the present invention, a method of tracking individuals utilizing the components described above may be sub-divided into four segments, namely: an enrollment personnel segment, a personnel fingerprint registration segment, a personnel tracking information download segment, and a remote tracking segment. These four segments are illustrated in FIGS. 10-13.

Referring to FIG. 10, a flow chart 1000 illustrates the personnel enrollment segment. In this segment, a server database application may be used to store information on all enrolled personnel to be tracked, at step 1001. At step 1002, a web based form is used to enter the appropriate personnel data into the master enrollment database. The amount and type of personnel data to be stored can be customized as desired. As such, an example of information to be stored in the master database may include: a name, a social security number or other unique identifier, a work location or routing information, an employer identification information, and a photograph. Thus, the base personnel information may be collected and stored in the master database prior to deployment via the Handheld module, at step 1003. The master database is used to verify relationship and status of each person, and also to store tracking information received from the handheld.

Referring to FIG. 11, a flowchart illustrates the personnel fingerprint registration segment, wherein members scan the appropriate finger on the PDA to create fingerprint data map points. The Map points will be sent to the master database and associated with existing personnel record. Thus, at step 1101, the Remote Administrator initiates a “Register Fingerprints” application. A login Webform is completed to verify “Personnel” for this task, at step 1102. Subsequently, a user performs a “Retrieve Personnel” selection by name and completes the Webform. which displays a “Register Personnel” dialog box(es). Then, a personnel member scans an appropriate finger on biometric device, and the Remote Administrator initiates a “Record Fingerprint” selection and saves the fingerprint map points, at step 1103. Further, the Remote Administrator may enter notes/remarks as required, at step 1104. Then, the Remote Administrator initiates a “Submit Button” selection to submit all recorded personnel data, and closes a “Register Personnel” Webform dialog, at step 1105.

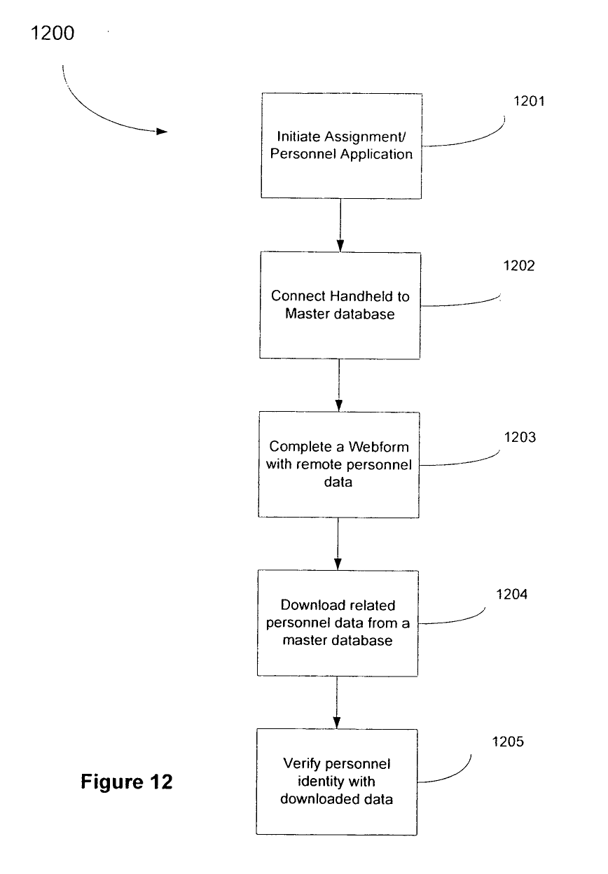

Referring to FIG. 12 a flow chart 1200 illustrates the download of personnel tracking information segment. In the download of “Personnel Tracking” tracking information segment, the Remote Administrator initiates an Assignment/Personnel application, at step 1201. Subsequently, the PPC is connected to the server application via the Internet, at step 1202. Then, a login Webform is completed to verify the Remote Administrator, at step 1203. Further, the Assignments/Personnel data is downloaded to the PPC from the master database, at step 1204. The Handheld software is then ready to verify personnel, at step 1205.

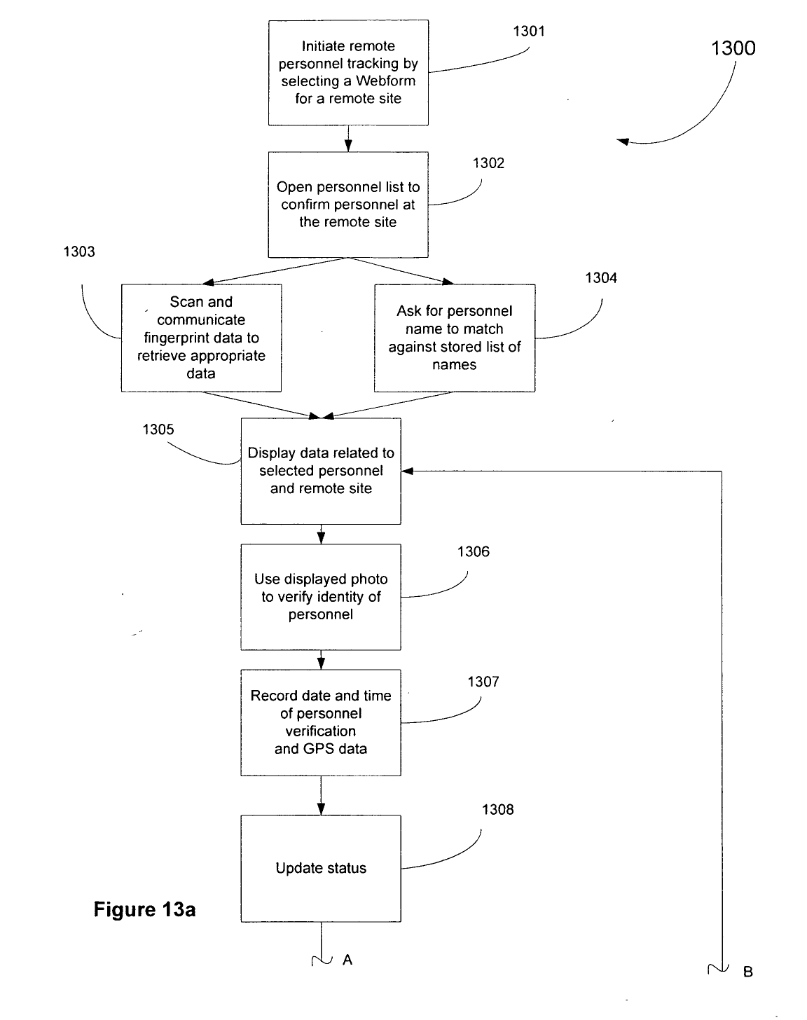

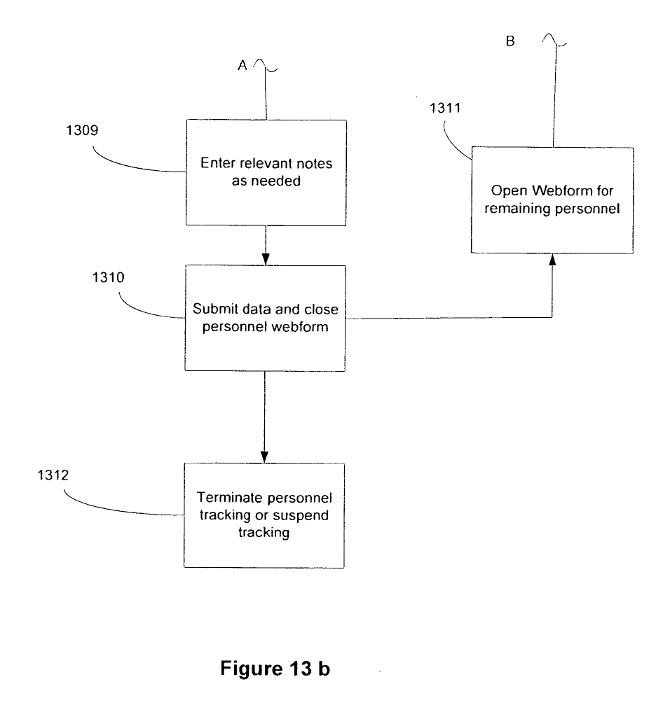

Referring to FIG. 13, a flow chart 1200 illustrates a procedure for for remote personnel tracking. In this segment, the Remote Administrator selects a Webform for the current remote site from available sites, at step 1301. The Remote Site is opened to reveal a Personnel list Webform, at step 1302. Subsequently, the Remote Administrator confirms the Personnel in one of two modes. In a first mode, the Personnel perfoms a fingerprint scan into PPC, and the Handheld software communicates with an appropriate API for the biometric device to validate and automatically retrieves the appropriate record, at step 1303. In a second mode, the Remote Administrator requests a name and selects the name from a list linked to the Webform, at step 1304. Subsequently, the Webform displays data corresponding to the current Remote Site and the selected Personnel, at step 1305. As a result, the Remote Administrator uses a displayed picture to perform a visual confirmation of the identity of the Personnel, at step 1306. Then, the Handheld software may record date and time of verification, at step 1307. Further, the Handheld software may communicate with an appropriate API for the GPS receiver to record the geographical location, at step 1307. If required, the Remote Administrator may select and update the status from an available list of status codes, wherein the status codes in the list can be customized based on the user's criteria, at step 1308. Further, the Remote Administrator may enter any relevant notes as desired or required, at step 1309. Then, the Remote Administrator may submit the filled Webform for storing and close the Personnel form dialog, at step 1310. As necessary, the Remote Administrator may loop back to step 1305 to further confirm all pertinent Personnel at the remote site required to be tracked, at step 1311. Once, all pertinent Personnel have been tracked, the Remote Administrator may close the open application or initiate a “Suspend Personnel Activity” selection to complete the process, at step 1312.

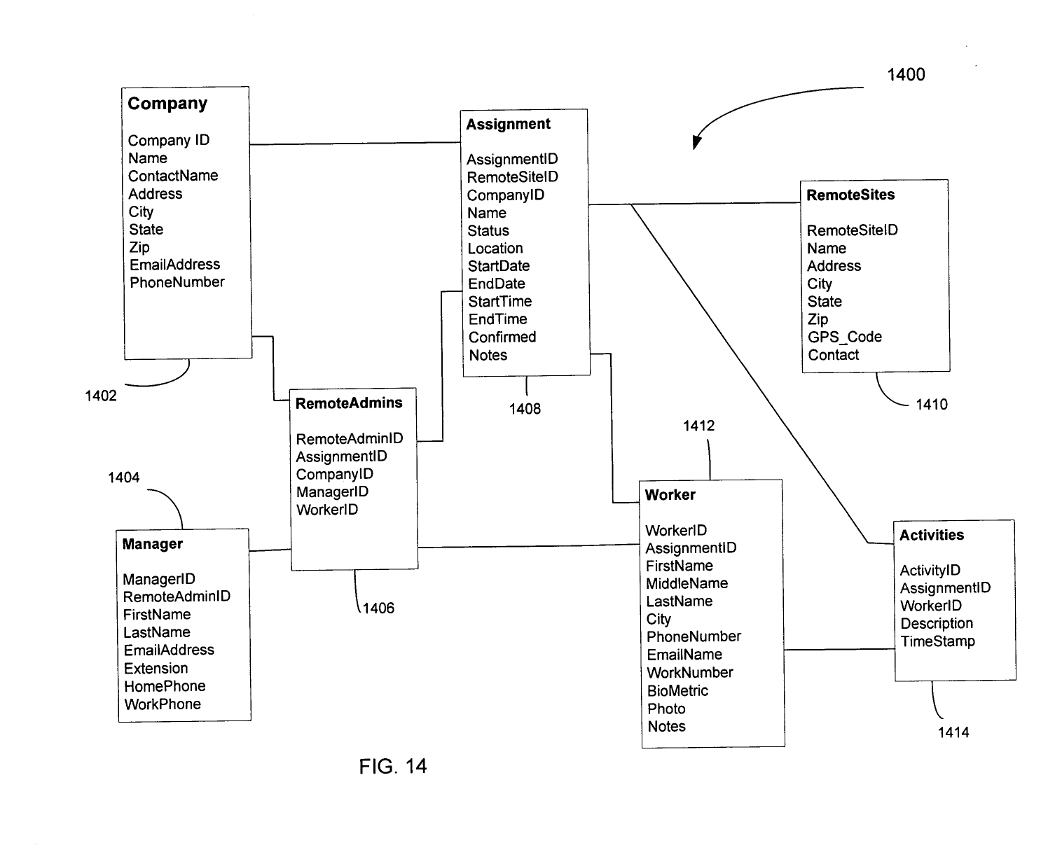

Referring now to FIG. 14, a server data is in schematic form illustrating the interrelationship of various data fields within the master database 120. The various data fields may include the following: a Company field 1402, a Managers field 1404, a Remote Administrator field 1406, an Assignments field 1408, a Remote Sites field 1410, a Workers field 1412, and an Activities field 1414. As such, the Company field 1402 may include the following data entries: CompanyID, Name, ContactName, CoantactTitle, Address, City, State, Zip, EmailAddress, and PhoneNumber. The Managers field 1404 may include the following data entries: ManagerID, RemoteAdminID, FirstName, LastName, EmailName, Extension, Homephone, and WorkPhone. The Remote Administrator field 1406 may include the following data entries: RemoteAdminID, AssignmentID, CompanyID, ManagerID, and WorkerID. The Assignments field 1408 may include the following data entries: AssignmentID, RemoteSiteID, CompanyID, Name, Status, Location, StartDate, StartTime, EndTime, Confirmed, and Notes. The RemoteSites field 1410 may include the following data entries: RemoteSitesID, Name, Address, City, State, Zip, GPSCode, and Contact. The Workers field 1412 may include the following data entries: WorkerID, AssignmentID, FirstName, MiddleName, LastName, City, PhoneNumber, EmailName, WorkNumber, BioMetric, Photo, and Notes. The Activities field 1416 may include the following data entries: ActivityID, AssignmentID, WorkerID, Description, and TimeStamp.

While preferred embodiments of the invention have been described, it should be understood that the invention is not so limited and modifications may be made without departing from the invention.

### TECHNICAL AND PREFERRED PARAMETERS

The following are technical parameters and various requirements contemplated presently for the above described embodiment of the invention.

The present embodiment is based on state of the art technology deployed by Microsoft in their Windows 2000 Server and MSMQ server based messaging system coupled with client side functionality hosted within their latest Internet Explorer web browser for PocketPC 2002.

The server requirements are presently contemplated as follows:

Windows 2000 Server;

MSMQ sever;

Internet Information Server version 5;

FrontPage 2002 server extensions; and

Microsoft SharePoint Portal Server.

As contemplated, the server is an implementation of MSMQ and SPP components extended to support the following custom functions:

Automated message composition, deployment and retrieval between Handheld and Configurator components;

Interface (non GUI) to customer supplied data, as required, in support of the Handheld and Configurator;

Content storage, maintenance and retrieval methods;

Interface to custom reporting of data collected from handhelds;

The system and method of the preferred, embodiment are supported by the following protocols, components, drivers, and object models:

WebDAV and XML Support;

XSL Support;

ADO/OLEDB Support;

MSMQ;

Web Storage System (WSS);

WSS Forms Registry;

The handheld requirements are as follows:

Windows PocketPC 2002;

Pocket Internet Explorer;

GPS receiver and associated API's;

Biometric device and associated API's;

Connectivity to Internet:

via WAN using standard wireless cellular or PCS networks, which requires TDMA, CDPD or GMS/GPRS. expansion cards or cellular phone connectivity cables,

via LAN using Internet connection of a PC or laptop, which requires Bluetooth, WLAN (802.11b), or serial cable to connect.

The Handheld component is an implementation of a Pocket Internet Explorer client configured to the following specifications:

Pocket PC PDA w/dual Compact Flash (CF) slot sleeve;

Biometric fingerprint device with API's and/or standard software for Fingerprint enrollment and verification;

GPS receiver device with API's and/or standard software for location recognition via the U.S. Department of Defense Global Positioning Satellite;

Custom software for matching biometric confirmation to real time, authorized user data;

Custom software for photo verification of identity;

Custom software for capturing and storing GPS location information; and

Custom software for automating transmission of information via the Internet.

Regarding device compatibility considerations, biometric fingerprint minutiae map (Map) control files for PDA's are proprietary. Most control files are designed to handle small number of users for device security. Also, the biometric device vendors expected local device enrollment to be relatively static and certainly not shareable or easily mutable. Preferably, the database is flexible enough to handle a large amount of biometric data and a large number of biometric records. More specific requirements are as follows:

Windows 2000 Server (W2K) with Internet Information Services (IIS5) provides secure, portal access to program and system components and user, confirmation and location data;

MSMG provides method of transfer and transact user, confirmation and location data;

Internet Explorer 6.0 or higher (IE6) provides GUI access, both full client and web based, to centralized user, confirmation and location data;

Network or Internet connection provides wired and/or wireless real time transport for user, confirmation and location data;

Windows Powered Pocket PCs w/PocketPC version 2002 (PPC) provides mobile access for the remote administrator to interact with remote users and the Server resources;

Pocket Internet Explorer (PIE) provides handheld GUI access for remote confirmation and location data activities;

Biometric fingerprint device (Bio) provides the ability for a remote administrator to validate remote users by capturing their fingerprint IDs;

Global Positioning System device (GPS) provides location-aware services to capture geographical coordinates for confirmation and location transactions;

Custom software (Custom) provides the automated methods to control and integrate the disparate hardware and software components of the Suite.

1. A person tracking device comprising:
a person identification unit for capturing biological data of a person being tracked;
a location determining unit in communication with the person identification unit for capturing location data of the person being tracked; and
a wireless communication unit for communicating the captured biological and location data of the person being tracked to a tracking site.

2. The person tracking device as in claim 1 wherein the person identification unit is a biometric reader.

3. The person tracking device as in claim 2 wherein the biometric reader provides the ability for a remote user to record and validate biological data of the person being tracked.

4. The person tracking device as in claim 1 wherein the location determining unit is a Global Positioning System (GPS).

5. The person tracking device as in claim 1 wherein the wireless communication unit is a transceiver for operably communicating with the tracking site.

6. A system for an automated tracking of a person at a remote site comprising:
a person tracking device for capturing data related to biological and location data of a person being tracked;
a Global Positioning System (GPS) database, in communication with the person tracking device, for certifying the location data of the person being tracked;
a personal enrollment center including a master database for storing biological and location data of the person being tracked, the master database in communication with the person tracking device; and
a communication network for operably connecting the person tracking device, the master database, and the GPS database;
wherein the tracking device compares the captured biometric data of the person being tracked with the stored biometric data of registered persons to validate the identity of the person being tracked or to record the captured biometric data of the person being tracked as a non-registered person, and communicates the captured data and location data to the master database.

7. The system as in claim 6 wherein the personal enrollment center further comprises:
an enrollment workstation for entering biometric and personal data, into the master database, of persons being registered; and
an Ethernet network for operably connecting the enrollment workstation and the master database to the communication network via an ISP.

8. The system as in claim 6 wherein the personal tracking device further comprises a biometric registration module for extracting the biometric data to be communicated to the master database via the communication network.

9. The system as in claim 6 wherein the personal tracking device further comprises a data recording module for assembling the biometric and tracking data to be communicated to the master database via the communication network.

10. The system as in claim 8 wherein the biometric recording module further comprises a biometric reader application interface for matching and validating the biometric data against a local stored user list, the list being compiled as a subset from the master database, and wherein the biometric data is assembled in an Extensible Markup Language (XML) message to be communicated via the communication network to update the master database.

11. The system as in claim 9 wherein the data recording module further comprises a GPS application interface for activating the GPS reader to retrieve location data from GPS satellites, wherein the location data, and date and time are assembled in a message queue record and communicated via the communication network to the master database.

12. The system as in claim 6 wherein the personal enrollment center further comprises a personal set module, operating on the server, for entering initial personal data into the master database;

13. The system as in claim 6 wherein the personal enrollment center further comprises an update module, operating on the server, for automatically communicating records to be tracked on the personal tracking device;

14. The system as in claim 12 wherein the personal enrollment center further comprises a tracking module, operating on the server, for providing tracking data to a report or a web screen.

15. The system as in claim 6 wherein the master database operates on a server, the server being a Windows 2000 server, an MSMQ server; an Internet Information server; a FrontPage 2002 server, a Microsoft Share Point Portal server, or the like.

16. The system as in claim 6 wherein the wireless communication network utilizes communication protocols, the communication protocols being Time Division Multiple Access (TDMA), Cellular Digital Packet Data (CDPD), or Global Management System/General Packet Radio Service (GMS/GPRS).

17. A method for an automated tracking of persons at remote sites, the method comprising:
establishing a wireless network by providing a person tracking device at a remote site, the person tracking device comprising a biometric reader, a GPS receiver, a data recording module, and a transceiver in wireless communication with the network, and the network further comprising a GPS database and a personal enrollment center including a master database;
storing personal, picture and biometric data of registered persons in the master database;
capturing biometric data of a person being tracked via the biometric reader;
capturing location data of the person being tracked via the GPS receiver;
identifying the tracked person via a validation of the captured biometric data against pre-stored biometric data in the data recording module; and
communicating the captured biometric data and location data to update a tracking module associated with the master database or to record the captured biometric data of the person being tracked as a non-registered person within a personnel setup module.

18. The method as in claim 12, wherein storing personal and biometric data further comprises:
entering personal data using a web based form into the master database, the personal data being used to verify a relationship and status of each registered person; and
registering scanned fingerprints of each registered person using map points.

19. The method as in claim 12, wherein capturing biometric data further comprises:
scanning an appropriate finger of a tracked person on the biometric reader; and
creating fingerprint data map points.

20. The method as in claim 12, wherein identifying of the tracked person further comprises:
utilizing name of the tracked person to select from pre-recorded list of registered persons; and
performing visual confirmation using a stored picture of the selected registered person.

21. A method for enrolling a person in a personal tracking system, the method comprises:
initiating a server database application for storing data of a person to be tracked;
entering personnel data for storage in the server database; and
forwarding the personnel data to a personnel tracking device.

22. A method for registering a person fingerprint on a person tracking device at a remote site, the method comprises:
initiating a register fingerprint application;
scanning an appropriate finger for recording map points;
entering corresponding personnel, location, date and time data in a form; and
forwarding recorded fingerprint map points, and entered data to a master database via a communication network.

23. A handheld tracking device comprising:
a person identification unit for capturing biological data of a person being tracked;
a location determining unit in communication with the person identification unit for capturing location data of the person being tracked; and
a wireless communication unit for communicating the captured biological and location data of the person being tracked to a tracking site.

24. The handheld tracking device as in claim 21 wherein the the handheld is selected from a laptop, a handheld computer, and a mobile telephone.
